(19) United States
(12) Patent Application Publication
(10) Pub. No.: US 2025/0158845 A1
(43) Pub. Date: May 15, 2025

(54) AUDIO DATA PUSHING METHOD, APPARATUS AND SYSTEM, AND ELECTRONIC DEVICE AND STORAGE MEDIUM

(71) Applicant: Beijing Bytedance Network Technology Co., Ltd., Beijing (CN)

(72) Inventors: Wenfeng LI, Beijing (CN); Zhicheng LIN, Beijing (CN)

(21) Appl. No.: 18/725,523

(22) PCT Filed: Dec. 26, 2022
(86) PCT No.: PCT/CN2022/141762

§ 371 Date: Jun. 28, 2024

(30) Foreign Application Priority Data
Dec. 30, 2021 (CN) 202111653968.0

(51) Int. Cl. H04L 12/18; H04M 3/56

(52) U.S. Cl. CPC H04L 12/1859; H04M 3/568

(57) ABSTRACT

Embodiments of the present disclosure disclose an audio data pushing method, apparatus and system, and an electronic device and a storage medium. The method applied to a central server includes: acquiring audio data having undergone first screening uploaded by at least one edge server; and performing second screening on the audio data according to a preset screening strategy, and pushing at least one channel of target audio data determined by the second screening to the at least one edge server, so as to enable the at least one edge server to push the target audio data to a corresponding target client.

The present application claims priority to Chinese patent application No. 202111653968.0 filed in China Patent Office on Dec. 30, 2021, the entire disclosure of which is incorporated herein by reference as part of the present application.

### TECHNICAL FIELD

Embodiments of the present disclosure relate to a field of data communication technology, and for example, to an audio data pushing method, apparatus and system, and an electronic device and a storage medium.

### BACKGROUND

At present, in an online conference participated by a plurality of (N) participants, a “full subscription” mode is adopted for transmission of audio data, in which any participant has to firstly subscribe to (N-1) channels of audio stream other than his/her own audio stream, if he/she wants to hear voices of other participants besides his/her own. Then, according to an audio stream subscription relationship among a plurality of participants, a conference server pushes several audio streams with higher volume from an audio publishing end subscribed by the participants to a corresponding participant client.

However, the respective participants in the online conference each have a subscription relationship with others; and as the number of participants increases, pressure of such subscription will increase exponentially, generating a large number of audio data links. Moreover, performance of an edge conference server has a significant impact on an online conference system. The complex audio subscription relationships cause the edge server to have excessive CPU resource consumption and have certain limitation on the number of participants. thereby affecting overall smoothness of the online conference.

### SUMMARY

Embodiments of the present disclosure provide an audio data pushing method, apparatus and system, and an electronic device and a storage medium, in which target audio data may be selected through multi-level audio data screening and actively pushed to a target client without handling complex audio subscription relationships by a server, may improve processing capability of a conference system and support a conference with more participants

In a first aspect, an audio data pushing method applied to a central server is provided by embodiments of the present disclosure. This method includes:
Acquiring audio data having undergone first screening uploaded by at least one edge server, and
Performing second screening on the audio data according to a preset screening strategy, and pushing at least one channel of target audio data determined by the second screening to the at least one edge server, so as to enable the at least one edge server to push the target audio data to a corresponding target client.

In a second aspect, an audio data pushing method applied to an edge server is also provided by embodiments of the present disclosure. This method includes:
Acquiring audio data uploaded by a client, and performing first screening on the audio data according to a preset screening strategy; and
Pushing the audio data having undergone the first screening to a central server for second audio data screening.

In a third aspect, an audio data pushing apparatus configured on a central server is also provided by embodiments of the present disclosure. This apparatus includes:
A first-screening data acquisition module, configured to acquire audio data having undergone first screening uploaded by at least one edge server; and
A first data pushing module, configured to perform second screening on the audio data according to a preset screening strategy, and push at least one channel of target audio data determined by the second screening to the at least one edge server, so as to enable the at least one edge server to push the target audio data to a corresponding target client.

In a fourth aspect, an audio data pushing apparatus configured on an edge server is also provided by embodiments of the present disclosure. This apparatus includes:
An audio data first-screening module, configured to acquire audio data uploaded by a client, and perform first screening on the audio data according to a preset screening strategy; and
A second data pushing module, configured to push the audio data having undergone the first screening to a central server for second audio data screening.

In a fifth aspect, an audio data pushing system is also provided by an embodiment of the present disclosure. This system includes: a central server and at least one edge server,
The central server is configured to implement any audio data pushing method; and
The at least one edge server is configured to implement any audio data pushing method.

In a sixth aspect, an electronic device is also provided by embodiments of the present disclosure. This electronic device includes:
One or more processors; and
A storage apparatus, configured to store one or more programs,
The one or more programs, when executed by the one or more processors, cause the one or more processors to implement the audio data pushing method applied to a central server or to an edge server according to any embodiment of the present disclosure.

In a seventh aspect, a storage medium including computer executable instructions is also provided by embodiments of the present disclosure. The computer executable instructions, when executed by a computer processor, are configured to execute the audio data pushing method applied to a central server or to an edge server according to any embodiment of the present disclosure.

### BRIEF DESCRIPTION OF THE DRAWINGS

Throughout the drawings, same or similar reference signs refer to same or similar elements. It should be understood that, the drawings are schematic and that originals and elements are not necessarily drawn to scale.

FIG. 1 is a schematic flow chart of an audio data pushing method applied to a central server provided by an embodiment of the present disclosure;

FIG. 2 is a schematic flow chart of an audio data pushing method applied to an edge server provided by an embodiment of the present disclosure;

FIG. 3 is a schematic structural diagram of an audio data pushing apparatus configured on a central server provided by an embodiment of the present disclosure;

FIG. 4 is a schematic structural diagram of an audio data pushing apparatus configured on an edge server provided by an embodiment of the present disclosure;

FIG. S is a schematic structural diagram of an audio data pushing system provided by an embodiment of the present disclosure; and

FIG. 6 is a schematic structural diagram of an electronic device provided by an embodiment of the present disclosure.

### DETAILED DESCRIPTION

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect.

As used herein, the term “include”, “comprise” and their variants are open-ended including, that is, “including but not limited to”. The term “based on” is “at least partially based on”. The term “one embodiment” means “at least one embodiment”. The term “another embodiment” means “at least one other embodiment”. The term “some embodiments” means “at least some embodiments”. Related definitions of other terms will be given in the following description.

It should be noted that the concepts of “first” and “second” mentioned in the present disclosure are only used to distinguish different devices, modules or units, and are not used to limit the order or interdependence of the functions performed by these devices, modules or units.

It should be noted that the modifications of “a”, “an” and “a plurality of” mentioned in the present disclosure are schematic rather than limiting, and those skilled in the art should understand that unless the context clearly indicates otherwise, they should be understood as “one or more”.

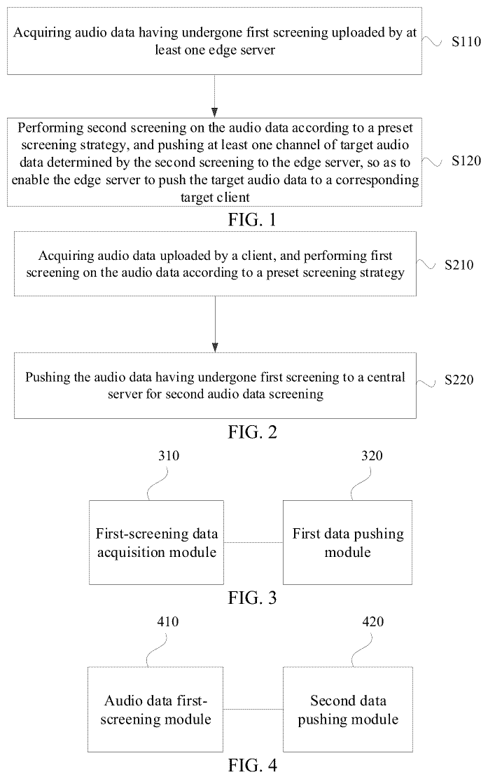

FIG. 1 is a schematic flow chart of an audio data pushing method applied to a central server provided by an embodiment of the present disclosure; and the embodiment of the present disclosure is applicable to a scenario of multi-participant online communication, and for example, to a situation of multi-participant online conference. The method may be executed by an audio data pushing apparatus configured on the central server; and the apparatus may be implemented in a form of software and/or hardware. The apparatus may be configured in an electronic device, for example, a mobile terminal or a server device.

As shown in FIG. 1, the audio data pushing method applied to the central server provided by this embodiment, includes:

S110: acquiring audio data having undergone first screening uploaded by at least one edge server.

During multi-participant online communication, for example, a multi-participant net conference or a multi-player game in a gaming room, each person may be a speaker, sending out audio data through a client having a multi-participant online communication function, so that other user client receives and plays the audio data. Each person may also be a listener, receiving audio data from other user through a client having a multi-participant online communication function.

In the related art, a plurality of users for online communication adopt a full subscription mode, in which each user keeps an audio data transmission link with other user, and audio data of each user will be forwarded to all user clients having a subscription relationship with the user, so as to implement transmission of audio data of speech of the user.

In this embodiment, the audio data is screened and actively pushed by the server, without keeping a subscription relationship between the plurality of users. For example, in the scenario of multi-participant online communication, user clients in different regions access to different edge servers, a client will collect corresponding audio data to upload to an edge server when a user is speaking, then the edge server uploads the collected audio to a core server, and the core server forwards the same to other edge server. For example, in this embodiment, when uploading the audio data to the core server, the edge server pre-screens the audio data received thereby, rather than uploading audio data uploaded by all users. That is, the audio data of speech of the plurality of users undergoes first screening by the edge server before being sent to the central server.

A strategy for the edge server to screen audio data may be a screening strategy set according to a specific scenario. In the conference scenario, a demand of the client for audio data is relatively clear, that is, to listen to several channels of audio data with the highest volume in the room (except that of the current client per se). The edge server may upload the several channels (which may be 2 channels, 3 channels, or other preset number of channels) of audio data with the highest volume among the received audio data. Or, the edge server may also determine a speaker client by recognizing audio data metadata and upload audio data of a designated user. The designated user may be a host or other important speaker. After the edge server uploads the audio data having undergone the first screening, the central server may receive the audio data having undergone the first screening.

S120: performing second screening on the audio data according to a preset screening strategy, and pushing at least one channel of target audio data determined by the second screening to the edge server, so as to enable the edge server to push the target audio data to a corresponding target client.

There are usually a large number of edge servers, so the central server also receives a large amount of audio data having undergone first screening, which requires screening. The strategy for second audio data screening may be the same as or different from the strategy for first audio data screening.

For example, among all the audio data having undergone the first screening, a preset amount of audio data with higher volume is further screened as target data. For example, each edge server screens out 4 channels of audio data through the first screening and uploads the same to the central server. The central server receives a total of 20 channels of audio data uploaded by 5 edge servers. For example, the central server needs to screen out several channels of audio data with higher volume from the 20 channels of audio data through the second screening, or audio data of a designated user, or a combination of the audio data of the designated user and the audio data with the highest volume. The corresponding audio data screening strategy may be set according to actual application scenarios.

After undergoing the second audio data screening and determining the target audio data, the central server will push the target audio data to a plurality of edge servers, to inform the plurality of edge servers of the target audio data to be pushed to the client For example, the audio data includes metadata information and an audio data packet. The metadata requires use of session description protocol (SDP) in information interaction of real-time communication media, which mainly includes session information and media information, for example, information such as link address of a client having collected the target audio data, time limit on audio data transmission, transmission port number, encoding type, encoding parameters, etc. The central server will push the metadata of the target audio data to each of the edge servers, to inform the edge server of the target audio data that needs to be pushed, and also push the audio data packet of the target audio data to the edge server whose uploaded audio data does not include the corresponding target audio data. That is, when the target audio data includes audio data A, there is no need to push audio data A to the edge server uploading audio data A.

Correspondingly, after receiving the target audio data, the plurality of edge servers may send the target audio data to the corresponding client, implementing active push of audio data, so that the edge servers break through the limit on the number of user subscription relationship links in the past, and may carry more client users.

The technical solution according to the embodiments of the present disclosure. involves: acquiring, by the central server, the audio data having undergone first screening uploaded by at least one edge server: performing second screening on the audio data having undergone the first screening according to a preset screening strategy; and then pushing at least one channel of target audio data determined by the second screening to the edge server, so as to enable the edge server to push the target audio data to the corresponding target client, thereby implementing the distributed transmission process of the audio data. The technical solution of the embodiments of the present disclosure solves the problem in the multi-user audio transmission scenario in the related art in which the complex audio subscription relationships cause the edge server to have excessive CPU resource consumption and have lower upper limit on the number of users it can carry, and allows the target audio data to be selected through multi-level audio data screening and actively pushed to the target client without handling complex audio subscription relationships by the server, which may improve processing capability of a conference system and support a conference with more participants

The embodiments of the present disclosure may be combined with respective solutions in the audio data pushing method applied to the central server provided by the above-described embodiments. For the audio data pushing method applied to an edge server provided by this embodiment, the process of performing first screening on audio data on the edge server and pushing the audio data is described.

FIG. 2 is a schematic flow chart of an audio data pushing method applied to an edge server provided by an embodiment of the present disclosure. As shown in FIG. 2. the audio data pushing method applied to the edge server provided by this embodiment includes:

S210: acquiring audio data uploaded by a client, and performing first screening on the audio data according to a preset screening strategy.

In a scenario where communication data needs to be transmitted between a plurality of users such as a multi-participant online conference, the client firstly collects audio data of a user, and when volume of the audio data reaches a preset volume threshold, uploads the audio data of the user to the edge server connected with the client. This indicates that there is indeed a voice of the user rather than environmental noise.

After acquiring audio data from a plurality of clients, each edge server will perform first screening on the received audio data according to the preset screening strategy. In the conference scenario or other scenario, usually a demand of the client is to listen to several channels of audio data with the highest volume (except for that of the current client per se) among the audio data. The several channels (which may be 2 channels, 3 channels, or other preset number of channels) of audio data with the highest volume among the received audio data may be taken as a result of first audio data screening. In an embodiment, the edge server may also determine whether the client uploading the audio data is a designated user client by recognizing audio data metadata, and take the audio data of the designated user as one of the results of the first screening. The designated user may be a host or other important speaker.

S220: pushing the audio data having undergone first screening to a central server for second audio data screening.

After determining the audio data having undergone the first screening, the edge servers may upload the audio data screened out through the first screening to the central server, so that the central server may perform second screening on the audio data screened out by the plurality of edge servers through the first screening, and determine target audio data finally to be pushed to the client. The audio data screened out through the first screening and pushed to the central server includes metadata and an audio data packet. The metadata includes attribute information such as identification and encoding information of the audio data.

For example, meanwhile, the edge servers may further receive a result of the second audio data screening pushed by the central server, and then push target audio data in the result of the second audio data screening to the client. For example, the edge servers may determine the client uploading the target audio data according to the metadata information of the target audio data, judge whether the client uploading the target audio data is a client that has established a connection therewith, and then, push the target audio data to clients other than the client uploading the corresponding target audio data according to the judgment result. Exemplarily, the target audio data received by edge server 1 is audio data A, audio data B and audio data C. Audio data A is audio data collected and uploaded by client a having a connection relationship therewith; then, audio data B and audio data C are pushed to client a. While none of other clients having a connection relationship with edge server 1 are clients collecting audio data A, audio data B and audio data C, so edge server 1 will push audio data A, audio data B and audio data C to the clients having a connection relationship with edge server 1 other than client a. This allows audio data to be synchronized in a multi-participant online conference scenario.

The technical solution according to the embodiments of the present disclosure involves: acquiring, by the edge server, the audio data uploaded by the client, performing first screening on the audio data, then uploading the result of the first data screening to the central server for second screening; acquiring, by the edge server, the result of the second screening performed by the central server on the audio data, and pushing the channel of target audio data determined by the second screening to the corresponding client, thereby implementing a distributed transmission process of the audio data. The technical solution of the embodiments of the present disclosure solves the problem in the multi-user audio transmission scenario in the prior art in which the complex audio subscription relationships cause the edge server to have excessive CPU resource consumption and have lower upper limit on the number of users it can carry, and allows the target audio data to be selected through multi-level audio data screening and actively pushed to the target client without handling complex audio subscription relationships by the server, which may improve processing capability of a conference system and support a conference with more participants.

FIG. 3 is a schematic structural diagram of an audio data pushing apparatus configured on a central server provided by an embodiment of the present disclosure. The audio data pushing apparatus configured on the central server provided by this embodiment is applicable to a multi-participant online communication scenario, and for example, is applicable to a multi-participant online conference scenario.

As shown in FIG. 3, the audio data pushing apparatus configured on the central server includes: a first-screening data acquisition module 310 and a first data pushing module 320.

The first-screening data acquisition module 310 is configured to acquire audio data having undergone first screening uploaded by at least one edge server; and the first data pushing module 320 is configured to perform second screening on the audio data according to a preset screening strategy, and push at least one channel of target audio data determined by the second screening to the edge server, so as to enable the edge server to push the target audio data to a corresponding target client.

The technical solution of the embodiments of the present disclosure involves: acquiring, by the central server, the audio data having undergone first screening uploaded by at least one edge server; performing second screening on the audio data having undergone the first screening according to a preset screening strategy; and then pushing at least one channel of target audio data determined by the second screening to the edge server, so as to enable the edge server to push the target audio data to the corresponding target client, thereby implementing the distributed transmission process of the audio data. The technical solution of the embodiments of the present disclosure solves the problem in the multi-user audio transmission scenario in the prior art in which the complex audio subscription relationships cause the edge server to have excessive CPU resource consumption and have lower upper limit on the number of users it can carry, and allows the target audio data to be selected through multi-level audio data screening and actively pushed to the target client without handling complex audio subscription relationships by the server, which may improve processing capability of a conference system and support a conference with more participants.

In some embodiments, the first data pushing module 320 is configured to:
Push metadata of the target audio data to each of the edge servers; and
Push an audio data packet of the target audio data to the edge server whose uploaded audio data does not include the corresponding target audio data.

The audio data pushing apparatus configured on the central server provided by the embodiments of the present disclosure may execute the audio data pushing method applied to the central server provided by any embodiment of the present disclosure, and has corresponding functional modules and advantageous effects for executing the method.

It is worth noting that the units and modules included in the above-described apparatus are only divided according to functional logic, but are not limited to the above-described division, as long as the corresponding functions may be implemented: in addition, specific names of the functional units are only intended to facilitate distinguishing them from each other, and are not used to limit the scope of protection of the embodiments of the present disclosure.

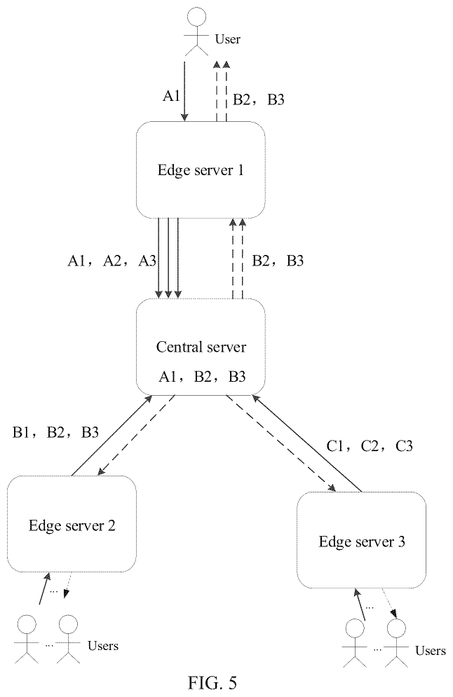

FIG. 4 is a schematic structural diagram of an audio data pushing apparatus configured on an edge server provided by an embodiment of the present disclosure. For the audio data pushing apparatus configured on the edge server provided by this embodiment, the process of performing first screening on audio data on the edge server and pushing the audio data is described.

As shown in FIG. 4, the audio data pushing apparatus configured on the edge server includes: an audio data first-screening module 410 and a second data pushing module 420.

The audio data first-screening module 410 is configured to acquire audio data uploaded by a client, and perform first screening on the audio data according to a preset screening strategy; and the second data pushing module 420 is configured to push the audio data having undergone first screening to a central server for second audio data screen.

The technical solution according to the embodiment of the present disclosure involves: acquiring, by the edge server, the audio data uploaded by the client, performing first screening on the audio data, then uploading the result of first data screening to the central server for second screening; acquiring, by the edge server, the result of the second screening performed by the central server on the audio data, and pushing the channel of target audio data determined by the second screening to the corresponding client, thereby implementing a distributed transmission process of the audio data. The technical solution of the embodiments of the present disclosure solves the problem in the multi-user audio transmission scenario in the prior art in which the complex audio subscription relationships cause the edge server to have excessive CPU resource consumption and have lower upper limit on the number of users it can carry, and allows the target audio data to be selected through multi-level audio data screening and actively pushed to the target client without handling complex audio subscription relationships by the server, which may improve processing capability of a conference system and support a conference with more participants.

In some embodiments, the audio data pushing apparatus configured on the edge server further includes:
A second-screening data receiving module, configured to receive a result of the second audio data screening fed back by the central server; and
A third data pushing module, configured to push target audio data in the result of the second audio data screening to the client.

In some embodiments, the third data pushing module is configured to:
Determine, according to metadata information of the target audio data, a client uploading the target audio data; and
Push the target audio data to a client other than the client uploading the target audio data.

The audio data pushing apparatus configured on the edge server provided by the embodiments of the present disclosure may execute the audio data push method applied to the edge server provided any embodiment of the present disclosure, and has corresponding functional modules and advantageous effects for executing the method.

It is worth noting that the units and modules included in the above-described apparatus are only divided according to functional logic, but are not limited to the above-described division, as long as the corresponding functions may be implemented; in addition, specific names of the functional units are only intended to facilitate distinguishing them from each other, and are not used to limit the scope of protection of the embodiments of the present disclosure.

FIG. 5 is a schematic structural diagram of an audio data pushing system provided by an embodiment of the present disclosure. The audio data pushing apparatus configured on the central server provided by this embodiment is applicable to a multi-participant online communication scenario, for example, is applicable to a multi-participant online conference scenario, and thus belongs to a same inventive concept as the audio data pushing method according to the above-described embodiment.

As shown in FIG. 5, the audio data pushing system includes: a central server and at least one edge server. In FIG. 5, only edge server 1, edge server 2 and edge server 3 are shown as examples, and the number of edge servers will not be limited.

Each edge server may be connected with clients of a plurality of users, receive audio data uploaded by the clients, and perform first screening on the received audio data. Wherein, edge server 1 performs first screening on the received audio data, to obtain three channels of audio data A1, A2 and A3; edge server 2 performs first screening on the received audio data, to obtain three channels of audio data B1, B2 and B3; and edge server 3 performs first screening on the received audio data, to obtain three channels of audio data C1, C2 and C3.

The central server will receive the audio data having undergone first screening uploaded by the respective edge servers, and perform second screening on the received audio data, to obtain three channels of target audio data A1, B2 and B3. For example, the central server will inform the respective edge servers of a result of second screening performed thereby on the audio data, and send the corresponding audio data to the respective edge servers. For example, since A1 is the audio data uploaded by edge server 1, only B2 and B3 will be pushed to edge server 1. Similarly, A1 is pushed to edge server 2, and A1, B2 and B3 are pushed to edge server 3.

Finally, the edge server will push the received target audio data having undergone second screening to the corresponding client, so as to implement audio data transmission and user interaction. Through a distributed architecture of the central server and the edge server, real-time communication capabilities of the edge server may be expanded, to support more users to participate in online communication (online conference).

When the central server and the edge server screen the audio data, the screening strategy is preset, which may be screening according to the volume of the audio data, or may also be recognizing and screening an object generating the audio data, or may also be a combination of the two, or may also be other screening strategy applicable to a multi-participant conference scenario. After multi-level selection of audio data channels, each edge server node may have a fixed number N of active speaker voices (corresponding to the number of pieces of target audio data), which may be approximately equivalent to voices of all active speakers in the entire online room.

The technical solution according to the embodiment of the present disclosure involves a distributed system architecture consisting of the edge server and the central server. Among the system, the edge server acquires the audio data uploaded by the client, performs first screening on the audio data, and then uploads the result of the first data screening to the central server; the central server performs second screening on the audio data; the edge server may further obtain the result of the second screening performed by the central server on the audio data, and push the channels of target audio data determined by the second screening to the corresponding clients, so as to implement a distributed transmission process of audio data. The technical solution of the embodiments of the present disclosure solves the problem in the multi-user audio transmission scenario in the prior art in which the complex audio subscription relationships cause the edge server to have excessive CPU resource consumption and have lower upper limit on the number of users it can carry, and allows the target audio data to be selected through multi-level audio data screening and actively pushed to the target client without handling complex audio subscription relationships by the server, which may improve processing capability of a conference system and support a conference with more participants.

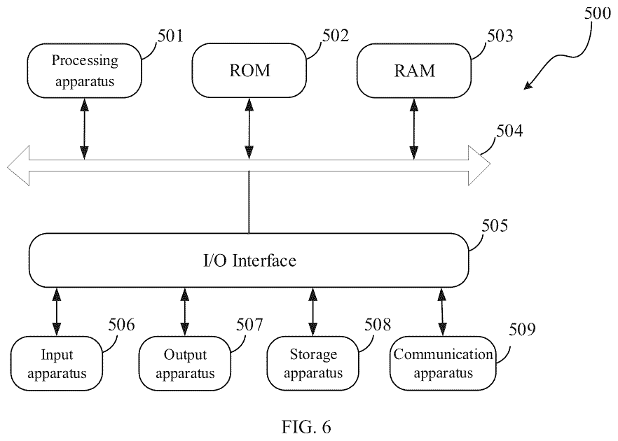

Referring to FIG. 6, FIG. 6 illustrates a schematic structural diagram of an electronic device (such as a terminal device or a server in FIG. 6) 500 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 6 is merely an example, and should not pose any limitation to the functions and the range of use of the embodiments of the present disclosure.

As illustrated in FIG. 6. the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 506 into a random-access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may be implemented or included alternatively.

For example, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the audio data pushing method applied to the center server or the edge server of some embodiments of the present disclosure are performed.

The electronic device provided by the embodiment of the present disclosure belong to a same disclosed concept as the audio data pushing method applied to the central server or to the edge server provided by the above-described embodiments. The above-described embodiments may be referred to for technical details not described in detail in this embodiment; and this embodiment has the same advantageous effects as the above-described embodiments.

The embodiment of the present disclosure provides a computer storage medium, having a computer program stored thereon. The program, when executed by a processor, implements the audio data pushing method applied to the central server or to the edge server provided by the above-described embodiment.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:
Acquiring audio data having undergone first screening uploaded by at least one edge server; and
Performing second screening on the audio data according to a preset screening strategy, and pushing at least one channel of target audio data determined by the second screening to the at least one edge server, so as to enable the at least one edge server to push the target audio data to a corresponding target client.

Or, the above-mentioned computer-readable medium carries one or more programs, and when the one or more programs are executed by the electronic device, the electronic device is caused to:
Acquiring audio data uploaded by a client, and performing first screening on the audio data according to a preset screening strategy; and
Pushing the audio data having undergone the first screening to a central server for second audio data screening.

The computer program codes for performing the operations of the present disclosure may be written in one or more programming languages or a combination thereof. The above-mentioned programming languages include but are not limited to object-oriented programming languages such as Java, Smalltalk, C++. and also include conventional procedural programming languages such as the “C” programming language or similar programming languages. The program code may be executed entirely on the user's computer. partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the data generation module may also be described as a “video data generation module”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present application, Example 1 provides an audio data pushing method applied to a central server, and this method includes:
Acquiring audio data having undergone first screening uploaded by at least one edge server; and
Performing second screening on the audio data according to a preset screening strategy, and pushing at least one channel of target audio data determined by the second screening to the edge server, so as to enable the edge server to push the target audio data to a corresponding target client.

According to one or more embodiments of the present application, Example 2 provides the audio data pushing method applied to the central server, and this method further includes:

In some embodiments, pushing the at least one channel of target audio data determined by the second screening to the edge server includes:
Pushing metadata of the target audio data to each of the edge servers; and
Pushing an audio data packet of the target audio data to the edge server whose uploaded audio data does not include the corresponding target audio data.

According to one or more embodiments of the present application, Example 3 provides an audio data pushing method applied to an edge server, and this method includes:
Acquiring audio data uploaded by a client, and performing first screening on the audio data according to a preset screening strategy; and
Pushing the audio data having undergone the first screening to a central server for second audio data screening.

According to one or more embodiments of the present application, Example 4 provides the audio data pushing method applied to the edge server, and this method further includes:
In some embodiments, receiving a result of the second audio data screening fed back by the central server, and
Pushing the target audio data in the result of the second audio data screening to the client.

According to one or more embodiments of the present application, Example 5 provides the audio data pushing method applied to the edge server, and this method further includes:

In some embodiments, pushing the target audio data in the result of the second audio data screening to the client includes:
Determining, according to metadata information of the target audio data, a client uploading the target audio data; and
Pushing the target audio data to a client other than the client uploading the target audio data.

According to one or more embodiments of the present application, Example 6 provides an audio data pushing apparatus configured on a central server, and this apparatus includes:
A first-screening data acquisition module, configured to acquire audio data having undergone first screening uploaded by at least one edge server; and
A first data pushing module, configured to perform second screening on the audio data according to a preset screening strategy, and push at least one channel of target audio data determined by the second screening to the at least one edge server, so as to enable the at least one edge server to push the target audio data to a corresponding target client.

According to one or more embodiments of the present application, Example 7 provides the audio data pushing apparatus configured on the central server, and this apparatus further includes:

In some embodiments, the first data pushing module, configured to:
Push metadata of the target audio data to each of the edge servers; and
Push an audio data packet of the target audio data to the edge server whose uploaded audio data does not include the corresponding target audio data.

According to one or more embodiments of the present application, Example 8 provides an audio data pushing apparatus configured on an edge server, and this apparatus includes:
An audio data first-screening module, configured to acquire audio data uploaded by a client, and perform first screening on the audio data according to a preset screening strategy; and
A second data pushing module, configured to push the audio data having undergone the first screening to a central server for second audio data screening.

According to one or more embodiments of the present application, Example 9 provides the audio data pushing apparatus configured on the edge server, and this apparatus further includes:

In some embodiments, the audio data pushing apparatus configured on the edge server further includes:
A second-screening data receiving module, configured to receive a result of the second audio data screening fed back by the central server; and
A third data pushing module, configured to push the target audio data in the result of the second audio data screening to the client.

According to one or more embodiments of the present application, Example 10 provides the audio data pushing apparatus configured on the edge server, and this apparatus further includes:

In some embodiments, the third data pushing module is configured to:
Determine, according to metadata information of the target audio data, a client uploading the target audio data; and
Push the target audio data to a client other than the client uploading the target audio data.

According to one or more embodiments of the present application, Example 11 provides an audio data pushing system and this system includes: a central server and at least one edge server,
The central server is configured to implement any audio data pushing method; and
The at least one edge server is configured to implement any audio data pushing method.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

1. An audio data pushing method applied to a central server, comprising:
acquiring audio data uploaded by at least one edge server, wherein the audio data has undergone first screening; and
performing second screening on the audio data according to a preset screening strategy, and pushing at least one channel of target audio data determined by the second screening to the at least one edge server, so as to enable the at least one edge server to push the target audio data to a corresponding target client.

2. The method according to claim 1, wherein pushing the at least one channel of target audio data determined by the second screening to the at least one edge server comprises:
pushing metadata of the target audio data to each edge server; and
pushing an audio data packet of the target audio data to the edge server when audio data uploaded by the edge server does not comprise the target audio data.

3. An audio data pushing method applied to an edge server, comprising:
acquiring audio data uploaded by at least one client, and performing first screening on the audio data according to a preset screening strategy; and
pushing the audio data having undergone the first screening to a central server for second audio data screening.

4. The method according to claim 3, further comprising:
receiving a result of the second audio data screening fed back by the central server; and
pushing target audio data in the result of the second audio data screening to the at least one client.

5. The method according to claim 4, wherein pushing the target audio data in the result of the second audio data screening to the at least one client comprises:
determining, according to metadata information of the target audio data, a client uploading the target audio data; and
pushing the target audio data to a client other than the client uploading the target audio data.

6. (canceled)

7. (canceled)

8. An audio data pushing system, comprising:
a central server and at least one edge server,
wherein the central server is configured to implement the audio data pushing method according to claim 1; and
the at least one edge server is configured to implement an audio data pushing method comprises:
acquiring audio data uploaded by at least one client, and performing first screening on the audio data according to a preset screening strategy; and
pushing the audio data having undergone the first screening to a central server for second audio data screening.

9. An electronic device, comprising:
one or more processors; and
a storage apparatus, configured to store one or more programs,
wherein the one or more programs, when executed by the one or more processors, cause the one or more processors to implement an audio data pushing method and the audio data pushing method is applied to an edge server and the audio data pushing method comprises:
acquiring audio data uploaded by at least one client, and performing first screening on the audio data according to a preset screening strategy; and
pushing the audio data having undergone the first screening to a central server for second audio data screening.

10. A storage medium, comprising computer executable instructions, wherein the computer executable instructions, when executed by a computer processor, are configured to execute the audio data pushing method according to claim 1.

11. The electronic device according to claim 9, wherein the audio data pushing method further comprises:
receiving a result of the second audio data screening fed back by the central server; and
pushing target audio data in the result of the second audio data screening to the at least one client.

12. The electronic device according to claim 11, wherein pushing the target audio data in the result of the second audio data screening to the at least one client comprises:
determining, according to metadata information of the target audio data, a client uploading the target audio data; and
pushing the target audio data to a client other than the client uploading the target audio data.

13. An electronic device, comprising:
one or more processors; and
a storage apparatus, configured to store one or more programs,
wherein the one or more programs, when executed by the one or more processors, cause the one or more processors to implement the audio data pushing method according to claim 1.

14. The electronic device according to claim 13, wherein pushing the at least one channel of target audio data determined by the second screening to the at least one edge server comprises:
pushing metadata of the target audio data to each edge server; and
pushing an audio data packet of the target audio data to the edge server when audio data uploaded by the edge server does not comprise the target audio data.

15. The storage medium according to claim 10, wherein pushing the at least one channel of target audio data determined by the second screening to the at least one edge server comprises:
pushing metadata of the target audio data to each edge server; and
pushing an audio data packet of the target audio data to the edge server when audio data uploaded by the edge server does not comprise the target audio data.

16. A storage medium, comprising computer executable instructions, wherein the computer executable instructions, when executed by a computer processor, are configured to execute the audio data pushing method according to claim 3.

17. The storage medium according to claim 16, wherein the audio data pushing method further comprises:
receiving a result of the second audio data screening fed back by the central server; and
pushing target audio data in the result of the second audio data screening to the at least one client.

18. The storage medium according to claim 17, wherein pushing the target audio data in the result of the second audio data screening to the at least one client comprises:
determining, according to metadata information of the target audio data, a client uploading the target audio data; and
pushing the target audio data to a client other than the client uploading the target audio data.

19. The audio data pushing system according to claim 8, wherein the audio data pushing method applied to the edge server further comprises:
receiving a result of the second audio data screening fed back by the central server; and
pushing target audio data in the result of the second audio data screening to the at least one client.

20. The audio data pushing system according to claim 19, wherein pushing the target audio data in the result of the second audio data screening to the at least one client comprises:
determining, according to metadata information of the target audio data, a client uploading the target audio data; and
pushing the target audio data to a client other than the client uploading the target audio data.

21. The audio data pushing system according to claim 8, wherein pushing the at least one channel of target audio data determined by the second screening to the at least one edge server comprises:
pushing metadata of the target audio data to each edge server; and
pushing an audio data packet of the target audio data to the edge server when audio data uploaded by the edge server does not comprise the target audio data.

22. The audio data pushing system according to claim 21, wherein the audio data pushing method applied to the edge server further comprises:
receiving a result of the second audio data screening fed back by the central server; and
pushing target audio data in the result of the second audio data screening to the at least one client.
